(19) United States
(12) Patent Application Publication
(10) Pub. No.: US 2026/0181355 A1
(43) Pub. Date: Jun. 25, 2026

(54) TWO-WAY TEXT SERVICE COMMUNICATION SYSTEM

(71) Applicant: Arcos, Inc., Columbus, OH (US)

(72) Inventors: Nicholas Clinton Nelson, Sandy, UT (US); Robert Scott Shultz, Lewis Center, OH (US); Lindsey Kropuenske Artman, Denver, CO (US); William Joseph Brackett, Powell, OH (US); Dov Stuart Rosenberg, Wyoming, OH (US)

(21) Appl. No.: 19/426,700

(22) Filed: Dec. 19, 2025

Related U.S. Application Data
(60) Provisional application No. 63/737,087, filed on Dec. 20, 2024.

(51) Int. Cl. H04W 4/029; H04W 4/14; H04W 4/90

(52) U.S. Cl. CPC H04W 4/029; H04W 4/14; H04W 4/90

(57) ABSTRACT

Methods and systems are described for a cross-platform communication management system for optimizing a two-way text communication system. A system can provide two-way crew communication, expense tracking, and/or check-in workflows in difficult environments. AI/ML tools can be used to optimize crew communication methods, issue resolution, expense tracking, and check-in workflows.

### CROSS REFERENCE TO RELATED APPLICATIONS

This application claims priority from U.S. Provisional Patent No. 63/737,087, filed on Dec. 20, 2024.

### TECHNICAL FIELD

The present disclosure generally relates to systems and methods for providing two-way text communication for service and disaster response logistics.

### BACKGROUND

There are many companies engaged in various disaster response services, such as power companies, water companies, debris removal, internet providers, cell phone service providers, and others. Often these companies struggle to communicate effectively with contractors in daily business, but especially while coordinating disaster response efforts. Communicating necessary information to disaster response crews is often a slow, inefficient process that leads to a slow, inefficient recovery effort.

### SUMMARY

One embodiment under the present disclosure comprises a two-way text communication system for service and disaster response logistics. The system comprises a processor and a memory storing instructions. The instructions can cause the processor to perform the steps of: transmit a check-in prompt to one or more crew computing devices; receive, from one or more crews, one or more data related to the one or more crews'location; transmit, to one or more crew management servers, the one or more data related to the one or more crews'location; and update one or more crew check-in data in the one or more crew management servers.

Another embodiment under the present disclosure is a method performed by a two-way text communication system for service and disaster response logistics. The method comprises receiving, from one or more crews, one or more data related to the one or more crews'location; transmit, to the one or more crew management servers, the one or more data related to the one or more crews'location; and update one or more crew check-in data in the one or more crew management servers.

Another embodiment under the present disclosure is a computer implemented method for training a machine learning model for optimizing a two-way text communication system for service and disaster response logistics. The method comprises obtaining a dataset of identified communication outcomes; training the machine learning model using the dataset of identified crew communication outcomes thereby obtaining a trained machine learning model; and storing the trained machine learning model.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of a two-way text communication system for service and disaster response logistics under the present disclosure;

FIG. 2 illustrates one embodiment of a method for crew member check-in under the present disclosure;

FIGS. 3A and 3B illustrate an embodiment of a method for crew lead check-in under the present disclosure;

FIG. 4 shows an example flow chart of a method for equipment and vehicle check-in under the present disclosure;

FIG. 5 shows an example flow chart of a method for managing a roster of available crews under the present disclosure;

FIG. 6 shows an example flow chart of a method for submitting and tracking crew expenses under the present disclosure;

FIG. 7 shows an example illustration of a crew member check-in procedure with identification and location verification;

FIG. 8 shows an example illustration of a mobile app user interface for crew and crew member communication;

FIG. 9 shows an example flow chart of training and inference pipelines for machine learning in accord with some embodiments under the present disclosure;

FIG. 10 shows an embodiment of a neural network under the present disclosure;

FIG. 11 shows an embodiment of a computing device for use in various embodiments under the present disclosure;

FIG. 12 illustrates one possible method embodiment under the present disclosure; and

FIG. 13 illustrates one possible method embodiment under the present.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the disaster response and services industry. In disaster response situations, crew managers often cannot effectively communicate with crews in the field or incoming crews. These crews might be made up of employees of the crew manager's company but may also include third party crews such as those associated with contractors or other third parties (such as in the case of the electric utility industry's mutual assistance groups). Often companies utilize multiple methods of communication to communicate the same information among varying crews or are stuck using one-way communication methods. Both present their own set of challenges. Utilizing multiple methods of communication leads to delays in critical information or delays in crew assignments. One-way communication only allows communication from the crew manager, but lacks the ability to receive useful information from crews and for crews to ask key questions. This often leads to delays or complications. Using an app can be difficult because availability or distribution of that app to third parties may be difficult due to timing, security, or willingness of the third parties, and in some scenarios, mobile data availability may be limited or unavailable.

Current approaches to coordinating disaster response crews suffer from fundamental limitations that impede efficiency and reliability. Traditional check-in processes typically begin only after crews arrive at a staging site, which often creates delays that cascade into slower restoration timelines. Existing mobile app solutions assume stable data connectivity and pre-registration of participants, conditions that rarely exist in disaster scenarios where internet access is intermittent and many workers are temporary contractors. These workers often cannot or will not download proprietary apps, which often leaves managers without a practical means of engaging them. At the same time, large-scale events involving thousands of workers often overwhelm conventional text-based systems, which lack automation and/or structured workflows. Emergency broadcast platforms, while useful for one-way alerts, are not designed for two-way interaction, which prevents managers from receiving confirmations, location updates, and/or critical questions in real time. Collectively, these shortcomings often result in fragmented communication, manual intervention, and/or operational inefficiencies at moments when speed and clarity are paramount. As a result, there are numerous opportunities in this area, but often a struggle to implement disaster response solutions due to technical constraints in disaster response scenarios where internet access is often limited.

Certain aspects of the embodiments disclosed herein provide solutions to these or other challenges. Certain embodiments include various functionalities. Certain embodiments include a two-way text communication system for crews and crew managers. Certain embodiments include autonomous workflows based on keyword triggers or other triggers. Certain embodiments include a two-way text communication system comprising a neural network capable of identifying and triggering workflows based on text communications. Other embodiments comprise systems and methods for communication amongst crews, managers, and other parties.

Certain embodiments may provide one or more of the following technical advantages. Embodiments can achieve greater communication efficiency between crews and crew managers and/or allow for effective communication between crews and crew managers in situations where internet access is limited. Certain embodiments can collect large amounts of data to aid in optimizing workflows and overall communication.

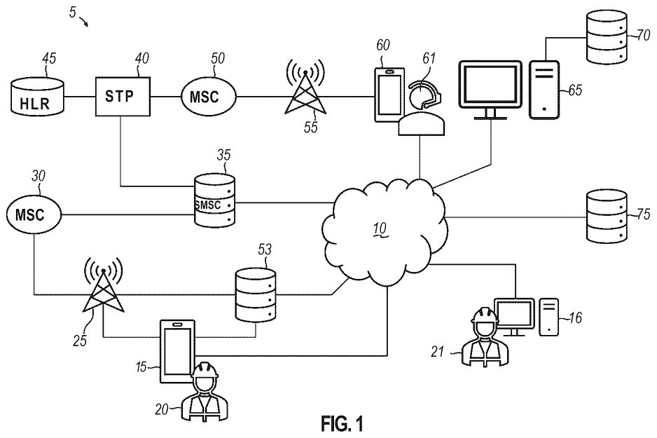

Referring now to FIG. 1, one embodiment of a two-way text communication management system 5 for service and disaster response logistics is shown. Such systems shall simply be referred to as communication management systems for purposes of the present disclosure. Crew members 20, 21 can use computing devices 15, 16 (e.g., computers, tablets, mobile devices, etc.) to send and receive communication via network 10 (e.g., Internet, cellular, Bluetooth^{TM}, Wi-Fi, satellite, enterprise, private network, similar networks, or combinations of the foregoing) or text (including e.g., SMS (short message service), MMS (multimedia messaging service), RCS (rich communication service), application messaging such as WhatsApp™, or a variety of other messaging applications). Crew manager 61 can send and receive communication via network 10 or via computing device 60 (e.g., computer, tablet, mobile device, etc.) as well. Server 70 may house a crew management system that crew manager 61 can access through a user interface 65. Server 75 may house a data management system, artificial intelligence/machine learning (AI/ML) functionalities, or other components for purposes of communicating with other components of FIG. 1. An AI/ML engine may be stored or operated at various computing devices within communication management system 5. Any or all of servers 70, 75 and/or computing devices 20, 21, 60 may comprise an AI/ML engine(s). AI/ML engines may comprise or perform AI/ML functionality as described further herein.

Computing devices 20, 21, and 60 may communicate directly with network 10 or by use of a text protocol 11. Text protocol 11 can comprise SMS, MMS, RCS, messaging applications such as WhatsApp, X™, Instagram™, Facebook Messenger™, Viber™, Signal™, or a variety of other applications with messaging capabilities. Computing device 20 may send message data to cell tower 25. Cell tower 25 may send message data to a message center 30. Message center 30 may send message data to a short message service center 35. Short message service center 35 (which can comprise other messaging related functionalities or components, such as a Multimedia Service Center (MMSC)) may send message data to signal transfer point 40. Signal transfer point 40 may then send message data to a home location register 45 and a message control center 50. Message control center 50 may send message data to cell tower 55. Cell tower 55 may send message data to computing device 60. Certain embodiments may utilize various texting or messaging applications (e.g. WhatsApp, X, Instagram, etc.). In such scenarios, SMS-related components (e.g., SMSC 35) may not be used for transmission of messages within such messaging applications. In such scenarios, computing device 15 or cell tower may provide messages to a messaging server 53 that may be operated by, or interoperate with e.g., WhatsApp, X, etc., which can then communicate with other components of system 5. These processes and components comprises an overall text protocol 11.

Several functionalities offered by e.g., communication management system 5 include: crew check-in management, conversation analytics, AI/ML-enhanced conversation and workflow tools, crew location tracking, identification confirmation, crew work assignment, crew schedule management, and others.

Crew check-in management: crew manager 61 can send a message (e.g., through text, email, application, etc.) including check-in instructions to all incoming crews or crew members 20, 21 by sending a message to computing devices 15, 16 based on a list of pre-made crew members. Crews or crew members 20, 21 may then respond through computing device 15, 16 (e.g., with either text or through an internet connection). Crews or crew members 20, 21 may respond with information regarding crew members present, available equipment, current location, available vehicles, safety briefing status, and other information. This check-in information may then be received by computing device 60. Computing device 60 may send the check-in information to network 10. Network 10 may share the check-in information with crew management system on server 70. Server 70 may update crew or crew members 20, 21 check-in status and/or update crew or crew members equipment, personnel, or other key information. Network 10 and/or server 70 may share check-in information with server 75. Server 75 may store check-in information in long term data storage, run AI/ML processes, analyze conversations, or otherwise use check-in information.

Conversation analytics: server 75 may store previous information from conversations between crew manager 61 and crews or crew members 20, 21. This conversation information may include crew or crew member name, company name, work location, equipment, task or issue, message timestamps, messages themselves, and/or other conversation information. Server 75 can then analyze the conversations through AI/ML such that patterns can be identified. Server 75 can then determine most common conversation topics, most common solutions, which crews or crew members 20, 21 have the most issues, which crews or crew members 20, 21 are regularly late or no-shows, or other preferred information. Data collection can be done by cookies, tags, opt-in sharing from crew manager 61 computing device 60, or other means of collection.

AI/ML-Enhanced Conversation and Workflow Tools: server 75 can receive information from the crew management server on server 70 or from network 10 such as crew or crew member 20, 21 arrival status, crew or crew member 20, 21 arrival time, crew type, crew equipment, conversation history, crew member names, crew member accommodation information, or other information. Server 70 can then transmit messages for use in conversation or as alerts from crew manager 61 to crew or crew members 20, 21. This data can be used to enhance or optimize communication between crew managers and crew members. For example, analyzing previous conversations and determining the most common issues crew members have or analyzing crew profiles. The data can show which issues are most common, which crews or crew members 20, 21 have the most issues, how efficient crews and crew members are, what crews are equipped to deal with what projects, or other determinations. Data collected can be used to optimize communications and/or project assignments through network 10 and/or crew manager 61 through computing device 60. For example, conversation analytics can be analyzed with AI/ML engine in server 75 to discover issues and solutions e.g., under-booking hotel rooms is a primary issue crews reach out about; a specific hotel regularly has issues; food restriction issues are most often solved by placing a new order to accommodate the food restriction; between 11:00 PM and 1:00 AM is when most issues are discovered; or other issues and solutions. Standard messages, standard workflows, and other content can be created and sent via network 10 and/or computing device 60. Standard workflows may be triggered within network 10 and may notify crew manager 61. Data collection can collect data on crew equipment, crew arrival times, crew members 20, 21, or other data. AI/ML engine from server 75 can formulate suggestions for crew manager 61. For example, server 75 may suggest a specific crew be sent to a specific project location based on arrival time, equipment, and crew members; server 75 may suggest a specific crew's accommodations be changed based on arrival time or another data point; server 75 may suggest a specific crew's food be ordered from a specific restaurant based on food restrictions; or other suggestions. The AI/ML engine in server 75 can be trained with conversation data and previous crew data. In certain embodiments, server 75 can trigger messages to be sent to crews or crew members 20, 21 such that crew manager 61 does not manually write and/or send messages to crews or crew members 20, 21.

Crew Location Tracking: server 70 can manage incoming crews or crew members 20, 21 based on location. Crew manager 61 can send a message using computing device 60 via text and/or network 10 to crews or crew members 20, 21 requesting location updates or estimated arrival time. Crews or crew members 20, 21 can respond using computing devices 15, 16. Responses may include dropping a location pin, messaging back an estimated arrival time, messaging back a location, sharing a location, sharing an incoming route, or other responses. In certain embodiments crews or crew members 20, 21 can be sent a link to be clicked that opens a webs browser that allows the system to get the location from the phone GPS. Server 70 can receive this information and update crew locations, arrival status, and/or other information based on the received information. If a location or incoming route is shared, server 70, in certain embodiments, can live track crew location. Crew manager 61 may have access to view this tracking through user interface 65 and/or computing device 60.

Identification Confirmation: server 70 can confirm crew members 20, 21 identities. Crew manager 61 or server 75 can request identification confirmation from crew members 20, 21 via network 10 and/or computing device 60. This request may be made via text protocol 11 or network 10. In certain embodiments, the request can include a link to an online submission portal. Crew members 20, 21 can follow the link where they can be prompted to take a photo of their state-issued identification card, work-issued identification, union card, and/or other identification. Crew members 20, 21 can use computing devices 15, 16 to take a photo of their identification and submit it through the submission portal. In certain embodiments, the request can prompt crew members 20, 21 to respond via text with a photo of their state-issued identification card, work-issued identification, union card, and/or other identification. Once an image of the crew members'20, 21 identification is received by computing device 60 and/or network 10, server 70 can cross-reference the previously provided information from crew members 20, 21 to confirm the identity of crew members 20, 21. Server 70 can then update the identification status of crew members 20, 21. In certain embodiments, server 70 may send an automated message back to crew members 20, 21 with the result of the identification confirmation process via text protocol 11 and/or network 10.

Crew Schedule Management: server 70 can manage varying crew schedules. Prior to crews being deployed to varying project locations, a list of projects to be completed is created. This list can be stored on server 70, 75. A list of potential crews is also created prior to crews being deployed. This list can also be stored on server 70, 75. Crew manager 61 can assign crews or crew members 20, 21 to projects using the previously made lists and computing device 60 and/or user interface 65. Server 70 can use these assignments to send messages to crews or crew members 20, 21 via text protocol 11 and/or network 10 asking them to check-in, complete safety briefings, provide updates on project progress, or other actions. Crews or crew members 20, 21 can respond with the requested information with computing devices 15, 16 via text protocol 11 or network 10. Server 70 can then automatically update the status of crews or crew members 20, 21 depending on the requested action and received response. In certain embodiments, crew manager 61 can automatically determine when crews or crew members 20, 21 are close to project completion and determine whether crews or crew members 20, 21 should move on to another project afterward, end their day, or otherwise determine crews or crew members'20, 21 next steps. This determination may be made by server 75 and an AI/ML engine based on given data.

One benefit of communication management system 5 is the collection of a large data source on crews, crew members, and the disaster response market and process generally. This data may be useful for crew trends, disaster response efficiencies, and other uses.

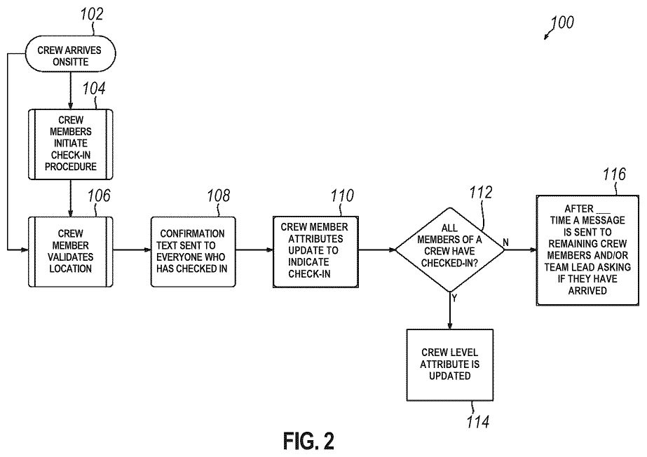

FIG. 2 illustrates one embodiment of a method for crew member check-in 100 under the present disclosure. Once a crew arrives on site 102, the crew members can initiate a check-in procedure 104. The check-in procedure 104 may include providing information about which crew members are part of the crew, the skillsets of the crew members, the equipment the crew is bringing, or other relevant information. The information provided by the crew may be compared to earlier provided information, update earlier provided information, or otherwise validate and/or edit earlier provided information. Initiating a check-in procedure 104 can be completed by using computing device 15, 16 from FIG. 1. Computing device 15, 16 may trigger the check-in procedure by sending a message via text protocol 11 and/or network 10. After crew members initiate a check-in procedure 104, or rather than initiating a check-in procedure 104, crew members can validate their location 106. This can be done at the request of crew manager 61 via text protocol 11 and/or network 10, or crew members can initiate this process. Location validation can be completed by a crew member sending a photo with location data, a pin, sharing location, or otherwise sending location data via text protocol 11 or network 10 such that server 70 can receive the location data. Server 70 can then cross-check the location data with the location the crew is meant to be. Server 70 can then update the location of the crew. After validating the crew member's location, server 70 can alert crew manager 61 via network 10 of crew member's status such that crew manager 61 can manually send a confirmation message via text protocol 11 and/or network 10. In certain embodiments, server 70 can formulate and send confirmation messages to crew members automatically upon location validation. After the confirmation message is sent, crew member attributes can be updated 110 in server 70 such that the updated attribute shows whether the crew member is properly checked in. As crew members check in, server 70 can determine whether all crew members on a particular crew have checked in 112. If all crew members have checked in, server 70 will update the crew attribute for check-in accordingly 114. If less than all crew members have checked in, server 70 will wait a predetermined amount of time for the remaining crew member(s) to check in. After that set period of time, server 70 will send an automated message to the crew member(s) that is not checked in and/or the team lead of the crew asking if the remaining crew member(s) has arrived 116. This can be done via text protocol 11 and/or network 10. Upon the crew's arrival, further validation such as in-person check of identification or other validation may be completed. In some embodiments, the method for crew member check-in 100 may begin before a crew arrives on site. If the method for crew member check-in 100 begins before a crew arrives on site, the crew may or may not validate location before arriving on site.

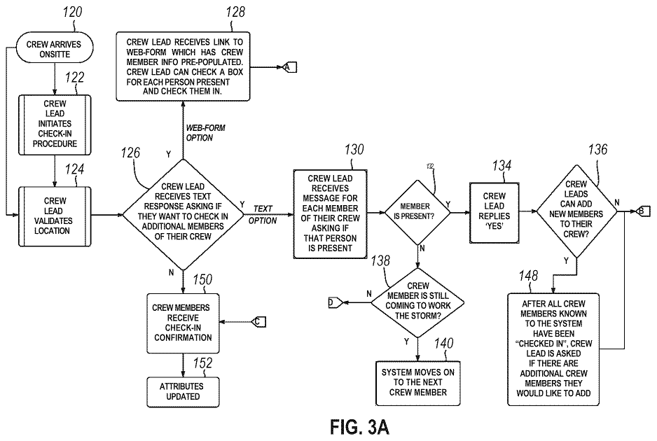

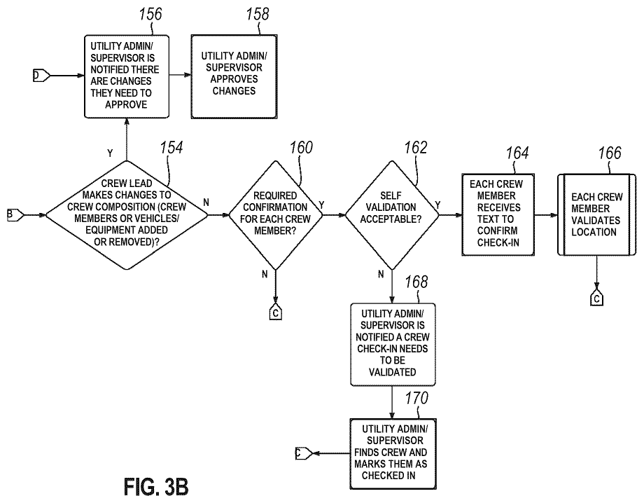

FIGS. 3A and 3B illustrate an embodiment of a method for crew lead check-in 118 under the present disclosure. First, a crew lead arrives on a project site 120. Then the crew lead can initiate a crew check-in procedure 122. This can be done by using a computing device with text protocol 11 and/or network 10, similar to the check-in procedure from FIG. 2. Then the crew lead can be prompted to validate location 124 via text protocol 11 and/or network 10. This can be completed by a crew member sending a photo with location data, a pin, sharing location, or otherwise sending location data via text protocol 11 or network 10 such that server 70 can receive the location data. Once the crew lead's location is validated, server 70 can send a message via text protocol 11 to the crew lead asking if the crew lead would like to check in additional crew members 126. If the crew lead does want to check in additional crew members, the crew lead can do so via text protocol 11. Next, crew manager 61 and/or server 70 determines which crew members on the crew lead's crew have not yet checked in. Crew manager 61 then sends a message via text protocol 11 to the crew lead for each crew member that has not checked in, asking if that crew member has arrived 130. In certain embodiments, server 70 may send the messages for each crew member asking if that crew member has arrived 130 via network 10 and text protocol 11 automatically. If the crew member asked about in the message is at the location 132, the crew lead can reply yes 134 via text protocol 11. Once server 70 receives the reply, server 70 updates that crew member's check-in status and sends a message to the crew lead asking if the crew leader wants to check in additional members from the previously determined crew 136. If the crew lead does not want to do so, the crew lead can send a negative response. Then the crew lead can then be asked if the crew lead wants to make changes to the crew composition 154. These changes can include adding or removing crew members; adding or removing vehicles or equipment; or other changes. If the crew leader does not want to make changes, the crew leader can send a negative response. Then the status of the crew members as recorded on server 70 may be confirmed 160. This confirmation may be done by the crew members themselves. If self-validation is acceptable 162, each crew member can receive a message via text protocol 11 asking for confirmation of their check-in status 164. The crew members then validate their location in order to validate their check-in status 166. Once all crew members are checked in and validated, the check-in process is complete.

If a crew member is not at the location 132, the crew lead receives a message asking if the crew member is still coming 138. If the crew member is still coming, the crew lead responds positively, and the system moves on to the next crew member to be checked in 140. If the crew member is no longer coming, the crew lead can respond negatively. Once the response is received by server 70, server 70 notifies crew manager 61 of the change and asks for approval 156. The crew manager 61 can then approve the changes 158. If the crew manager 61 does not approve the changes, an additional approval process may occur which may include a customer specific process for approval may begin, granting approval regardless of the crew manager 61, sending a message to the crew member to try again, or other process.

If the crew lead wants to add new crew members to the crew 136, the crew lead receives a message, after all crew members on the previously determined list on server 70 have been checked in, asking if there are any additional crew members the crew lead would like to add 148. If so, the crew lead can do so when asked if the crew lead wants to make changes to the crew composition 154.

If the crew lead wants to make changes to the crew composition 154, the crew lead can make those changes via text protocol 11 by using keyword or other triggers to add or remove the crew members, equipment, or vehicles. Once the response is received by server 70, server 70 notifies crew manager 61 of the change and asks for approval 156. The crew manager 61 can then approve the changes 158.

If crew members'check-in status does not require confirmation 160, the crew members will each individually receive a message requesting their check-in information 150. The crew members will then complete the check-in process individually. Once those responses are received by server 70, the crew members'attributes will be updated accordingly 152.

If crew members'check-in status does require confirmation 160 and self-validation is not acceptable, server 70 sends a notification to crew manager 61 stating that a crew check-in needs to be validated 168. Then crew manager 61 can manually locate the crew and manually confirm the check-in 170 and update server 70 attributes.

In certain embodiments, the crew lead can respond to the text message asking if the crew lead wants to check in additional members of the crew by clicking a link in the message 128 that leads to a web-form. The web-form may be pre-populated with crew member information such that the crew lead can check-in the present crew members. This may include check boxes for each crew members, scanning crew member identification, drop down boxes, or other confirmation options. Then the crew lead can then be asked if the crew lead wants to make changes to the crew composition 154, and the method for crew lead check-in 118 continues as described.

In certain embodiments, the crew lead may be asked via text message if the crew lead would like to check in additional members of the crew 126, and the crew lead may respond in the negative. If the crew lead does not want to check in additional crew members, the crew members themselves will each receive an individual message asking them to check themselves in 150. The crew members can then respond via text protocol 11 and/or network 10 with their status. Once the response is received by server 70, server 70 can update the crew members'attributes 152. Once the attributes are updated, the crew members can validate their location 166. After this is completed, the check-in process is deemed completed.

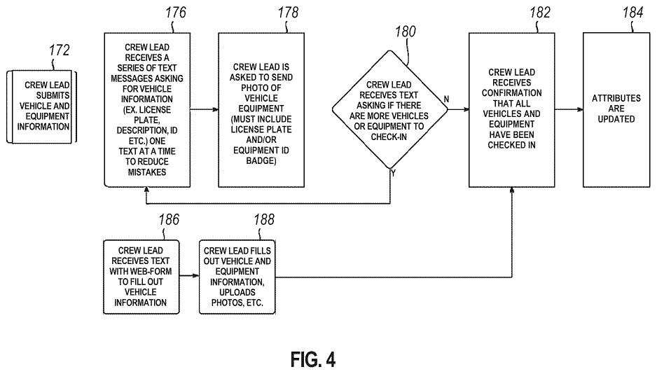

FIG. 4 shows an example flow chart of a method for equipment and vehicle check-in 172 under the present disclosure. In order for a crew lead to submit vehicle and/or equipment information, the crew lead can receive one or more text messages asking for vehicle or equipment information 176. To ensure mistakes are minimized, in certain embodiments only one message may be sent at a time until a response is received. Once the crew lead responds with the requested information for the specific vehicle or equipment, server 70 can record the information. Server 70 can then send a message the crew lead asking for a photo of the vehicle or equipment 178. The photo preferably includes the license plate, equipment identification badge, or other identifying information for the vehicle or equipment. Server 70 can then confirm the vehicle or equipment information based on the provided information and photo. After the vehicle or equipment information is confirmed, the crew lead can receive a text message asking if there are more vehicles or equipment to check in 180. If the crew lead responds in the negative, the crew lead can receive a confirmation message stating that all vehicles and equipment have been checked in 182. Then server 70 can update the vehicle and equipment attributes for that crew 184. In some embodiments, server 70 may include an AI/ML engine that may allow a crew lead include as much or as little information in each response such that the AI/ML engine can determine relevant and irrelevant information and store the information accordingly. The AI/ML engine may collect relevant information through conversation with the user, ensuring all required information is collected. Examples of AI/ML engine can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

If the crew lead has additional vehicles or equipment to check in 180, the process can restart with the crew lead receiving a series of text messages asking for vehicle or equipment information 176.

In certain embodiments, the crew lead receives a text message with a link to a webform to fill out vehicle information rather than a series of text messages 186. The crew lead can click the link, fill out the requested information for each vehicle and/or piece of equipment, and upload the required photos 188. After that is completed, the crew lead receives a confirmation message 182 and server 70 updates the vehicle and equipment attributes for that crew 184.

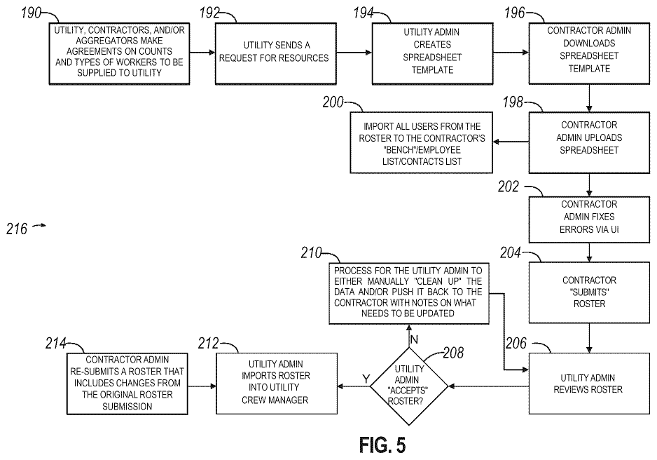

FIG. 5 shows an example flow chart of a method for managing a roster of available crews 216 under the present disclosure. Prior to disasters or other projects requiring many crews, utilities, contractors, and/or aggregators make agreements that include the number and type of workers to be supplied for the projects or disaster 190. When a utility needs assistance from outside contractors, aggregators, or other utilities, the utility can submit a request to a management server 192. This request for assistance can be submitted online. Once this request is received by the management server, a utility administrator can create a spreadsheet template 194 such that the contractor administrator can use the spreadsheet to track the crews and crew members it has agreements with. The utility administrator can then share the spreadsheet with the contractor administrator. The contractor administrator can then download the spreadsheet template 196. The contractor can then fill out the spreadsheet with the associated crews and crew members. Then the contractor can upload the completed spreadsheet 198 to the management server. The management server can then scan the uploaded spreadsheet for the crews and crew members and import them into the contractor's crew list 200. After the spreadsheet is imported, the contractor administrator can review the imported information and correct any errors via a user interface 202. Once the contractor administrator is satisfied with the crew list, the contractor administrator can submit the list 204. Then the utility administrator can review the list 206, which may include confirming consistency between the list 206 and previous information, confirming names, confirming identities of those on the list 206, confirming needs, or other relevant information. After reviewing the list, the utility administrator can accept or reject the roster 208. If the utility administrator rejects the roster, the utility administrator then must either manually fix the list and/or send the list back to the contractor administrator with notes on what needs to be fixed 210. Once the contractor administrator fixes the list and/or the utility administrator fixes the list, the utility administrator can review the list 206 again. Then the utility administrator can accept or reject the list 208. If the utility administrator accepts the list, the utility administrator can import the list into the utility crew manager 212. If after a list is uploaded, a contractor administrator determines the list needs to be updated or otherwise changed, the contractor administrator can resubmit a list with the needed changes 214. Then the utility administrator can import the new list into the utility crew manger to replace the old list 212.

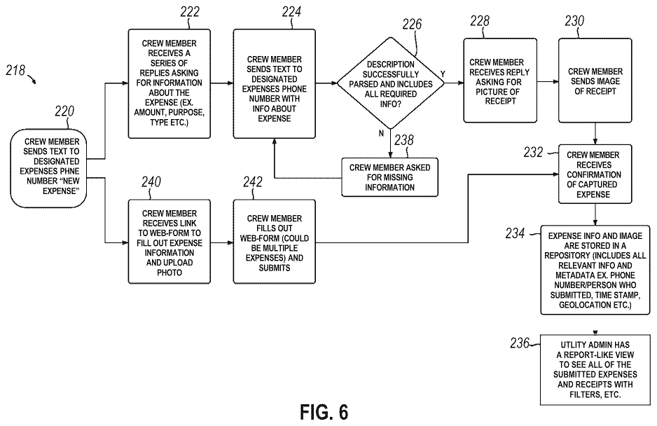

FIG. 6 shows an example flow chart of a method for submitting and tracking crew expenses 218 under the present disclosure. When a crew members needs to expense something, the crew member can send an text message to a designated expense phone number with a trigger phrase, e.g. “new expense” 220. In certain embodiments, the phone number may be a general phone number suitable for all correspondence from crew members or may otherwise be a multipurpose phone number, phone number specific to each information type, phone number specific for each employer, or other phone number. After the message is received by a computing device 60 and/or network 10, the crew member will receive a series of messages requesting varying information about the expense 222. This information may include the expense amount, purpose, type, recurrence, or other information. The crew member can then respond to the messages with the appropriate expense information 224 via text protocol 11 to the same phone number. Then the information provided by the crew member is analyzed by server 70 to ensure all necessary information has been provided 226. If the information is correct, the crew member will then receive a message asking for a photo of the receipt for the expense 228. The crew member then sends a photo of the receipt 230. Server 70 then can analyze the provided photo to ensure the information provided is accurate. The crew member then receives a message confirming that expense has been recorded 232. Then the expense information and photo are stored 234 on server 70. In certain embodiments, server 70 may store the information in a specified repository for expense information. The information may include the relevant expense information and/or metadata. This may include the crew member's phone number, crew member's name, message time stamps, receipt time stamps, geolocation data, or other information. The utility admin can then view a report showing all of the submitted expenses and receipts 236. In certain embodiments, the report includes filters or other subsets of information.

If the expense description provided by the crew member is not sufficient or is missing information 226, the crew member receives a message asking for the missing information 238. The crew member can then send the missing information 224. The method continues from there as described above. In some embodiments, an AI/ML engine may determine a type of expense, whether an expense should be approved, whether provided expense information is sufficient, or other determinations. If the AI/ML engine determines a follow-up message may be necessary, the AI/ML engine may generate and/or send the follow-up message to collect additional data, inform the crew member of the result of the expense procedure, or other relevant information.

In certain embodiments, after the crew member sends a message to the expense phone number 220, the crew member will receive a text message with a link to a webform 240 where the crew member can fill in the required expense information and upload a photo of the expense receipt. The crew member then can click the link and fill out the web form for one or more expenses 242. After the crew member submits the web form, server 70 can then analyze the provided photo(s) to ensure the information provided is accurate. The crew member then receives a message confirming that expense has been recorded 232, and the method continues from there as described above.

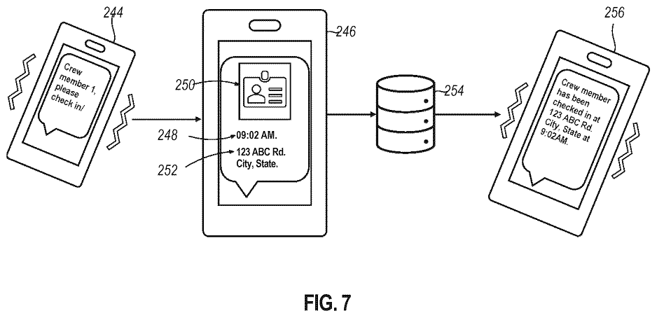

FIG. 7 shows an example illustration of a crew member check-in procedure with identification and location verification. Before crew members start arriving, crew members may receive a check-in message 244 such that the crew members have the check-in phone number. When a crew member arrives, the crew member may send a message 246 to the check-in phone number via text protocol 11. The message 246 may include a photo 250 of the crew member's identification. The photo 250 may include one or more data. The one or more data may include a timestamp 248, a location 252, or other message data. The message 246 may be sent via text protocol 11. The message 246 may then be received by a server 254 that can confirm the crew member's location 252. This may be done by confirming the location with a database of crew member locations or other methods. Server 254 can also store the message data including the crew member location 252, timestamp 248, and other message data. Once the crew member's location 525 is validated by server 254, server 254 can send a confirmation message 256 via text protocol 11 to the crew member. The confirmation message 256 may include confirmation of the crew member's location 525, timestamp 248, and other message data.

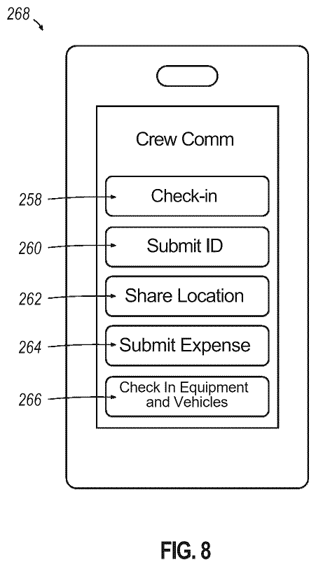

FIG. 8 shows an example illustration of a mobile app user interface 268 for crew and crew member communication. While many embodiments comprise text protocol 11, the present disclosure also includes mobile application embodiments, web embodiments, etc. These embodiments may include options for crew or crew member check-in 258, submitting identification 260, sharing location 262, submitting an expense 264, checking in equipment and/or vehicles 266, or other options. Varying user interfaces may be used to communicate with crews and crew members as included in this disclosure. These user interfaces may communicate via network 10 or other networks.

As described above, certain embodiments may incorporate AI/ML aspects.

### AI/ML Embodiments

Various embodiments under the present disclosure can incorporate AI/ML functionality. For example, for purposes of the present disclosure, servers 70, 75 and/or computing devices 15, 16, 60 of FIG. 1 can be said to comprise an AI/ML engine, either separately or together. Each component may comprise a separate instance of an identical AI/ML engine. Or a “central” AI/ML engine could be running at any location, such as servers 70, 75, and others of the foregoing devices could function like an output/input interface to the central AI/ML engine, allowing user input, data collection, user interface for a user, etc. As described above, servers 70, 75 may collect data from network 10, computing devices 15, 16, 60, or other devices, receive data from crews, crew members, crew leads, or crew managers, track crew communications, crew-provided information, photos, or otherwise receive or utilize a variety of other data. This data can be used to analyze what types of issues or expenses are the most common, the most common solutions to certain issues, typical crew check-in times, crew or crew member efficiencies, or other types of metrics. This data can also be used to train an AI/ML engine or can be analyzed by a previously trained AI/ML engine.

It should be understood that an AI/ML engine can comprise one or more AI/ML engines or models. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML engine is intended to denote a variety of AI/ML functionalities that fall under the category of AI or ML algorithms and systems that utilize such functionalities. Examples of AI/ML engine can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

In system 5 of FIG. 1, multiple AI/ML engines can be used. For example, one AI/ML engine can comprise a LLM-based chatbot that interacts with any crew member or crew lead 20, 21 to determine issues, perform check-in procedures, perform safety briefings, receive requests for expenses, or perform other tasks. It may be that multiple different LLMs are used. For example, one LLM might be trained on crew communications. Another might be trained on previous expense data. A different AI/ML engine may be stored or implemented at various of the components shown in FIG. 1. Alternatively, there may be a smaller number of AI/ML engines, and various of the components of FIG. 1 may function as user interfaces for a remote AI/ML engine stored at e.g., server 70, 75. Data used to train, retrain, or implement any of AI/ML engines may be stored at any one or more of the components shown in FIG. 1. A person of ordinary skill in the art will recognize that a variety of such variations are possible under the present disclosure.

In certain embodiments, the communication management system 5 may include a model context protocol (MCP) that may govern how contextual data is assembled, prioritized, and/or transmitted to one or more AI/ML engines, which may include the LLM-based chatbot described above. The MCP may provide a structured mechanism for defining context that may include conversation history, crew attributes, operational state, workflow metadata, and/or other context into a prompt optimized for token efficiency and/or relevance. By enforcing deterministic context segmentation, the MCP may ensure that critical information, such as crew check-in status, location updates, pending expense workflows, etc. is preserved while non-essential details are truncated or summarized according to policy.

The MCP may operate as an orchestration layer between servers 70 and 75 and an LLM inference pipeline. When an autonomous workflow is triggered (e.g., check-in confirmation, expense validation, roster adjustment, etc.), the MCP may retrieve relevant context slices from servers 70 and 75, apply token budgeting rules, and/or construct a composite prompt for the LLM. These rules may include prioritization of safety-critical messages, inclusion of prior resolutions for similar issues, dynamic compression of historical conversation threads, and/or other priorities. The MCP may also support hierarchical context injection, which may allow global policies, like disaster response protocols, to coexist with local crew-specific data in the same inference.

To maintain performance and reliability, the MCP may integrate with the model lifecycle management pipeline described below. During training and inference, the MCP may log context assembly decisions, token utilization metrics, and/or prompt-response mappings to server 75 for drift detection and continuous improvement. This may enable the AI/ML engine to adapt its summarization and/or reasoning strategies over time, which may reduce hallucination risk and/or improve workflow accuracy. In certain embodiments, the MCP can invoke fallback strategies, such as minimal context prompts and/or rule-based responses, when token limits are exceeded and/or when connectivity constraints prevent full context retrieval.

The architecture of an AI/ML engine (e.g., structure, number of layers, nodes per layer, activation function etc.) may need to be tailored for each particular use case. For example, properties to vary can include e.g.: crew characteristics (number of members, skillset, equipment, vehicles, etc.), crew member information, issue data, expense data, and a variety of other factors. These may all need to be considered when designing an AI/ML engine architecture.

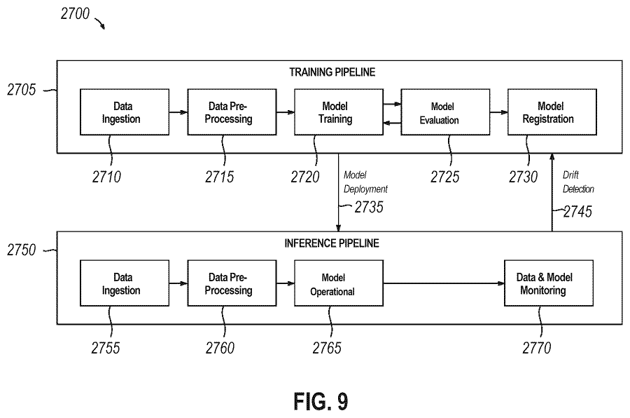

Building an AI/ML engine can include several development steps where the actual training of a ML model or algorithm is just one step in a training pipeline. An important part in AI/ML development is AI/ML model lifecycle management. One embodiment of a model lifecycle management procedure 2700 is illustrated in FIG. 9. The model lifecycle management can in some embodiments comprise two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets.

The loss function may be, for example, based on minimizing the number of messages; maximizing crew efficiencies; minimizing improper expenses, or other metrics. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., system 5 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a back propagation step, and a parameter optimization step. These steps can be described using a dense ML model (i.e., a dense NN with a bottleneck layer) as an example.
Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.
Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.
Parameter optimization: The gradients computed in the back propagation step are used to update the ML model's trainable parameters. An approach is to use the gradient descent method with a learning rate hyperparameter (α) that scales the gradients of the weights and biases. It is preferred to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(·) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in system 5 of FIG. 1 (e.g., in the form of simple vector-matrix multiplications).

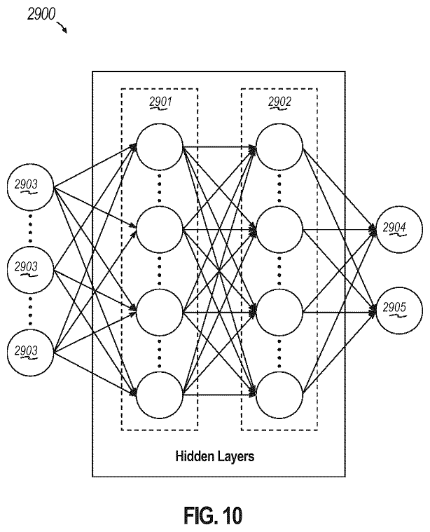

Referring now to FIG. 10, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., crew efficiency data, list of most common issues, losses due to expensing errors, suggested messages and/or solutions, or another output valuable. Possible inputs can include e.g.: crew communication data, crew location, crew industry, expensing data, or other variables.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

### Additional Embodiments

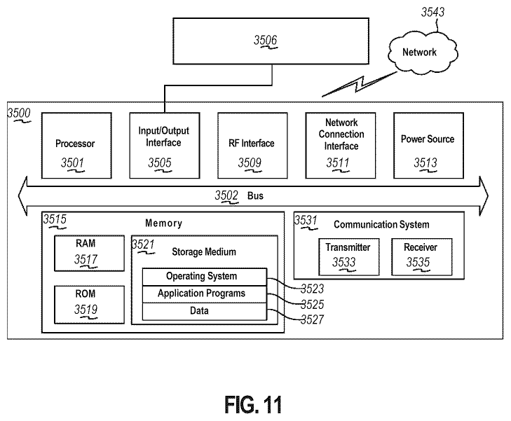

FIG. 11 illustrates an embodiment of various computing devices within system 5 of FIG. 1, or components thereof e.g., computing devices 15, 16, 60, server(s) 70, 75, which can comprise e.g., computers, tablets, servers, databases, mobile devices, or other computing or smart devices described herein. FIG. 11 shows a schematic block diagram of a computing device 3500 (or components thereof) according to certain embodiments of the present disclosure. System 3500 can be used to analyze and/or optimize: the functionalities described with respect to system 5 of FIG. 1 and its components, or to perform other methods, such as AI or ML-related tasks and analyses as described herein.

Computing device 3500 includes processor 3501 that is operatively coupled via a bus 3502 to an input/output interface 3505, a power source 3513, a memory 3515, a RF interface 3509, network communication interface 3511, and/or any other component, or any combination thereof. The level of integration between the components may vary from one embodiment to another. Further, certain computing devices 3500 (or components thereof) may contain multiple instances of a component, such as multiple processors, memories, transceivers, transmitters, receivers, etc.

The processor 3501 is configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide an interface or interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3513 is structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a simulation system or communication system may be tangibly embodied as or in memory 2515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated embodiment, communication functions of the RF interface 3509 or network connection interface 3511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

System 5 of FIG. 1, or computing devices 3500 as described above or in regard to FIG. 1, can perform a variety of method embodiments under the present disclosure. Several example method embodiments are given above but these examples are non-limiting and are only meant to illustrate certain embodiments.

Although the computing devices described herein (e.g., servers, computing devices, etc. of system 5 of FIG. 1) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

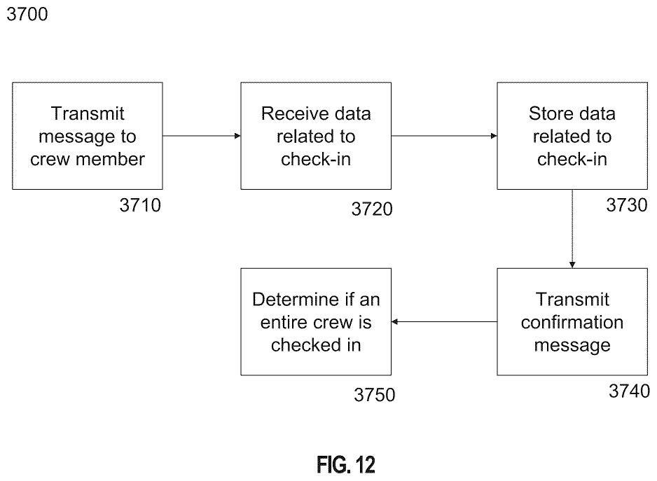

FIG. 12 illustrates one possible method embodiment under the present disclosure. Method 3700 is a method performed by a cross-platform communication management system for optimizing a two-way text communication system. Step 3710 is transmitting via text, to one or more crew members, one or more messages requesting crew member check-in data. Step 3720 is receiving, from the one or more crew members, one or more data related to crew member check-in. Step 3730 is storing the data related to crew member check-in status in the database. Step 3740 is transmitting via text, to the one or more crew members, one or more check-in confirmation messages. Step 3750 is determining if an entire crew is checked in. Method 3700 can comprise a variety of additional, alternative, and/or optional steps and/or other modifications. For example, some embodiments can further comprise: transmitting via text, to the one or more crew members, one or more messages requesting location data; receiving, from the one or more crew members, one or more data related to crew member location; analyzing the one or more data related to crew member location; and storing the one or more data related to crew member location in the database. In some embodiments, transmitting via text one or more messages requesting location data comprises requesting, via text, a location validation link; and wherein the one or more data related to crew member location comprises geolocation data obtained from a phone GPS. Some variations can further comprise: analyzing the one or more data related to crew member check-in status with a machine learning model; and optimizing the text check-in process with the analyzed one or more data related to crew member check-in. Some embodiments can further comprise: receiving, via text, an image of identification from the one or more crew members; extracting message metadata comprising a timestamp and location from the image; cross-referencing the image with previously provided crew member information; and updating an identification confirmation attribute for the crew member in the database. Some embodiments can further comprise: transmitting, via text, a link to a webform for equipment check-in; receiving equipment information and an associated photo through the webform; and storing the equipment information in the database with metadata comprising one or more timestamps and geolocation data. Some variations can further comprise:
aggregating one or more historical text communications between a crew manager and the one or more crew members; detecting a recurring issue pattern; determining one or more preferred solutions based on the recurring issue pattern; and providing, via text, a suggested resolution message to the crew manager. Some embodiments can further comprise: updating a roster of available crews by ingesting a contractor-provided spreadsheet into a crew management server;
and validating one or more imported crew identities against one or more previously stored attributes; and wherein determining if an entire crew is checked in comprises setting a crew-level check-in status based on the one or more roster of available crews.

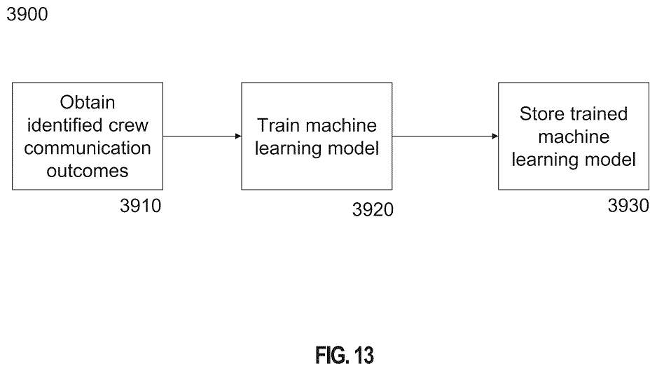

FIG. 13 illustrates one possible method embodiment under the present disclosure. Method 3900 is a computer implemented method for training a machine learning model for optimizing a two-way text communication system. Step 3910 is obtaining a dataset of identified crew communication outcomes. Step 3920 is training the machine learning model using the dataset of identified crew communication outcomes thereby obtaining a trained machine learning model. Step 3930 is storing the trained machine learning model. Method 3900 can comprise a variety of additional, alternative, and/or optional steps and/or other modifications. For example, some embodiments can further comprise training a machine learning model for optimizing identified crew communication outcomes, wherein the training comprises; training the machine learning model using a dataset of one or more identified crew communication outcomes, thereby obtaining a further trained machine learning model; and storing the further trained machine learning model. In some embodiments, the machine learning model uses one or more inputs comprising one or more of: crew communication data, crew location, crew industry, expensing data.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

What is claimed is:

1. A two-way text communication system for service and disaster response logistics, comprising:
a processor;
a database; and
a memory storing instructions whereby the processor is configured to perform the steps of;
transmit via text, to one or more crew members, one or more messages requesting crew member check-in data;
receive, from the one or more crew members, one or more data related to crew member check-in;
store the data related to crew member check-in in the database;
transmit via text, to the one or more crew members, one or more check-in confirmation messages; and
determine if an entire crew is checked in.

2. The system of claim 1, further comprising one or more computing devices configured to send and receive text messages.

3. The system of claim 1, wherein the instructions further cause the processor to perform the steps of:
transmit via text, to the one or more crew members, one or more messages requesting location data;
receive, from the one or more crew members, one or more data related to crew member location;
analyze the one or more data related to crew member location; and
store the one or more data related to crew member location in the database.

4. The system of claim 3, wherein transmit via text one or more messages requesting location data comprises request, via text, a location validation link; and wherein the one or more data related to crew member location comprises geolocation data obtained from a phone GPS.

5. The system of claim 1, wherein the instructions further cause the processor to perform the steps of:
analyzing the one or more data related to crew member check-in status with a machine learning model; and
optimizing the text check-in process with the analyzed one or more data related to crew member check-in.

6. The system of claim 1, wherein the instructions further cause the processor to perform the steps of:
receive, via text, an image of identification from the one or more crew members;
extract message metadata comprising a timestamp and location from the image;
cross-reference the image with previously provided crew member information; and
update an identification confirmation attribute for the crew member in the database.

7. The system of claim 1, wherein the instructions further cause the processor to perform the steps of:
transmit, via text, a link to a webform for equipment check-in;
receive equipment information and an associated photo through the webform; and
store the equipment information in the database with metadata comprising one or more timestamps and geolocation data.

8. The system of claim 1, wherein the instructions further cause the processor to perform the steps of:
aggregate one or more historical text communications between a crew manager and the one or more crew members;
detect a recurring issue pattern;
determine one or more preferred solutions based on the recurring issue pattern; and
provide, via text, a suggested resolution message to the crew manager.

9. The system of claim 1, wherein the instructions further cause the processor to perform the steps of:
update a roster of available crews by ingesting a contractor-provided spreadsheet into a crew management server; and
validate one or more imported crew identities against one or more previously stored attributes; and
wherein determining if an entire crew is checked in comprises setting a crew-level check-in status based on the one or more roster of available crews.

10. A method performed by a cross-platform communication management system for optimizing a two-way text communication system, comprising:
transmitting via text, to one or more crew members, one or more messages requesting crew member check-in data;
receiving, from the one or more crew members, one or more data related to crew member check-in;
storing the data related to crew member check-in status in the database;
transmitting via text, to the one or more crew members, one or more check-in confirmation messages; and
determining if an entire crew is checked in.

11. The method of claim 10, further comprising:
transmitting via text, to the one or more crew members, one or more messages requesting location data;
receiving, from the one or more crew members, one or more data related to crew member location;
analyzing the one or more data related to crew member location; and
storing the one or more data related to crew member location in the database.

12. The method of claim 11, wherein transmitting via text one or more messages requesting location data comprises requesting, via text, a location validation link; and wherein the one or more data related to crew member location comprises geolocation data obtained from a phone GPS.

13. The method of claim 10, further comprising:
analyzing the one or more data related to crew member check-in status with a machine learning model; and
optimizing the text check-in process with the analyzed one or more data related to crew member check-in.

14. The method of claim 10, further comprising:
receiving, via text, an image of identification from the one or more crew members;
extracting message metadata comprising a timestamp and location from the image;
cross-referencing the image with previously provided crew member information; and
updating an identification confirmation attribute for the crew member in the database.

15. The method of claim 10, further comprising:
transmitting, via text, a link to a webform for equipment check-in;
receiving equipment information and an associated photo through the webform; and
storing the equipment information in the database with metadata comprising one or more timestamps and geolocation data.

16. The method of claim 10, further comprising:
aggregating one or more historical text communications between a crew manager and the one or more crew members;
detecting a recurring issue pattern;
determining one or more preferred solutions based on the recurring issue pattern; and
providing, via text, a suggested resolution message to the crew manager.

17. The method of claim 10, further comprising:
updating a roster of available crews by ingesting a contractor-provided spreadsheet into a crew management server; and
validating one or more imported crew identities against one or more previously stored attributes; and
wherein determining if an entire crew is checked in comprises setting a crew-level check-in status based on the one or more roster of available crews.

18. A computer implemented method for training a machine learning model for optimizing a two-way text communication system, the method comprising:
obtaining a dataset of identified crew communication outcomes;
training the machine learning model using the dataset of identified crew communication outcomes thereby obtaining a trained machine learning model, and
storing the trained machine learning model.

19. The method of claim 18, further comprising training a machine learning model for optimizing identified crew communication outcomes, wherein the training comprises:
training the machine learning model using a dataset of one or more identified crew communication outcomes, thereby obtaining a further trained machine learning model; and
storing the further trained machine learning model.

20. The method of claim 18, wherein the machine learning model uses one or more inputs comprising one or more of: crew communication data, crew location, crew industry, expensing data.
